(19) United States
(12) Patent Application Publication
(10) Pub. No.: US 2026/0071806 A1
(43) Pub. Date: Mar. 12, 2026

(54) DEFROSTING SYSTEM AND METHOD FOR FREEZER

(71) Applicant: Bynasci Technology Co., LTD, Hangzhou (CN)

(72) Inventors: Tao MEI, Wuxi (CN); Dongxin JIA, Wuxi (CN)

(73) Assignee: Bynasci Technology Co., LTD, Hangzhou (CN)

(21) Appl. No.: 19/356,055

(22) Filed: Oct. 11, 2025

Related U.S. Application Data
(63) Continuation of application No. PCT/CN2025/084557, filed on Mar. 25, 2025.

(30) Foreign Application Priority Data
Sep. 9, 2024 (CN) 202411253289.8

(51) Int. Cl. F25D 21/12; B01D 53/06; B01D 53/26

(52) U.S. Cl. CPC F25D 21/12; B01D 53/06; B01D 53/261; B01D 2257/80; F25D 2317/0411; F25D 2321/147

(57) ABSTRACT

A defrosting system includes a freezer body and a dehumidification device with a desiccant rotor. The desiccant rotor includes a treatment region and a regeneration region. The dehumidification device is configured to reduce moisture in the freezer body and removes frost in the freezer body by means of the desiccant rotor. The dehumidification device includes a treatment air inlet and a treatment air outlet. The treatment air inlet is configured to draw to-be-treated air out of the freezer body. The treatment air outlet is configured to transport dry air, dehumidified by adsorption of the desiccant rotor, back into the freezer body. By adopting the defrosting system for a freezer, no condensate water is produced in the whole dehumidification process of the freezer, and no water needs to be drained out of the freezer.

This application is a continuation application of International Application No. PCT/CN2025/084557, filed on Mar. 25, 2025, which claims priority of Chinese Patent Application No.202411253289.8, filed on Sep. 9, 2024, which is incorporated herein by reference.

### FIELD

The present application relates to the technical field of freezers, in particular to a defrosting system and method for a freezer.

### BACKGROUND

Freezers are widely used in industry, commerce and agriculture, involving the industries of medicine, food, semiconductors, make-up and the like. At present, all freezers are typically classified, by temperature, into high-temperature freezers (5˜15° C.) , medium-temperature freezers (−5˜5° C.) , low-temperature freezers (−18˜−25° C.) , quick freezers (−35˜−40° C.) and deep freezers (−45˜−60° C.) , and the low-temperature freezers are mainstream freezers on the market. In recent years, with the rapid expansion and fierce market competition of cold-storage logistics, how to keep freezers efficient and intelligent to save labor and reduce energy consumption in operation becomes a problem urgently to be solved in the industry.

Because the temperature in the freezer is extremely low and the door needs to be frequently opened for storing goods and placing goods in the freezer or taking goods out of the freezer, external moisture will inevitably enter the freezer, leading to frosting in the freezer, such as on the surfaces of goods, the floor, the top of the freezer and positions close to the door. Although frosting in these positions will not cause an increase in energy consumption, it may result in safety problems, such as slipping on the floor. In addition to frosting in these positions of the freezer, the main intractable problem is frosting on fins of a heat exchanger of, for example, a freezer using air coolers for refrigeration, which will lead to blockage a period of time later; in addition, frosting on surfaces of the fins will reduce heat-exchange efficiency and increase refrigeration energy consumption. For a freezer using aluminum pipes for refrigeration, frosting on the aluminum pipes will cause the same problems. In view of this, regular defrosting is necessary for the freezers to guarantee normal operation of the freezers. At present, common defrosting methods and their problems are as follows:
(1) Electric defrosting, which has the following problems: power consumption is high; water draining is needed after defrosting, and residual water will be iced again in the freezers or on the fins, so defrosting is incomplete.
(2) Hot fluoride defrosting, which has the following problems: the defrosting time is long, and defrosting is incomplete; in addition, if defrosting is carried out too many times or too frequently, a fault of a refrigeration system may be caused, leading to a high risk.

### SUMMARY

The objective of the application is to provide a defrosting system and method for a freezer, which are used for dehumidification and defrosting in the freezer.

The objective of the application is fulfilled by the following technical solutions:

In one aspect, the present application provides a defrosting system for a freezer. The defrosting system comprises a freezer body; and a dehumidification device comprising a desiccant rotor which comprises a treatment region and a regeneration region, the dehumidification device being configured for reducing moisture in the freezer body and removing frost in the freezer body by means of the desiccant rotor. The dehumidification device comprises a treatment air inlet and a treatment air outlet, the treatment air inlet is configured to draw to-be-treated air out of the freezer body, and the treatment air outlet is configured to transport dry air, dehumidified by adsorption of the desiccant rotor, back into the freezer body.

In some optional embodiments, a refrigeration device, which is configured to provide a cold source for the freezer body, is arranged within the freezer body; and the dry air is transported to the refrigeration device via the treatment air outlet to remove frost on the refrigeration device.

In some optional embodiments, the freezer body is provided with a return pipe and an air supply pipe, the return pipe is connected to the treatment air inlet, and the air supply pipe is connected to the treatment air outlet.

In some optional embodiments, the dehumidification device is located outside the freezer body, the air supply pipe comprises an external section located outside the freezer body and an internal section located inside the freezer body, the external section communicates with the internal section, and a plurality of air outlet holes facing the refrigeration device are formed in a surface of the internal section.

In some optional embodiments, all or at least part of the dehumidification device is located inside the freezer body, and a plurality of air outlet holes facing the refrigeration device are formed in a surface of an air supply pipe.

In some optional embodiments, the freezer body is provided with a freezer door, the return pipe is provided with an extension pipe, and an air inlet end of the extension pipe is arranged above the freezer door and used for sucking air entering the freezer body via the freezer door.

In some optional embodiments, the dehumidification device is a dehumidifier which comprises a regeneration air inlet and a regeneration air outlet, the regeneration air inlet is configured to transport regeneration air to an air inlet side of the regeneration region of the desiccant rotor to realize desorption regeneration of the regeneration region of the desiccant rotor, and the regeneration air outlet is configured to discharge the regeneration air, discharged from an air outlet side of the regeneration region of the desiccant rotor, out of the dehumidifier; and the treatment air inlet is configured to transport the to-be-treated air to an air inlet side of the treatment region of the desiccant rotor to realize dehumidification of the to-be-treated air by absorption, and the treatment air outlet is configured to discharge the dry air, discharged from an air outlet side of the treatment region of the desiccant rotor, out of the dehumidifier.

In some optional embodiments, the dehumidifier further comprises an electric heating component arranged on the air inlet side of the regeneration region of the desiccant rotor and configured to increase a temperature of the regeneration air.

In some optional embodiments, the defrosting system further comprises a heat-exchange component for increasing the temperature of the regeneration air, and the heat-exchange component is arranged at the regeneration air inlet, connected to a condensation end of the refrigeration device and configured to increase a temperature of the heat-exchange component.

In some optional embodiments, the defrosting system further comprises an air source heat pump arranged at the regeneration air inlet and configured to provide the regeneration air to realize desorption and dehumidification of the regeneration region of the desiccant rotor.

In some optional embodiments, the dehumidifier further comprises a first sealing element arranged on the air inlet side of the treatment region and the air outlet side of the regeneration region of the desiccant rotor. The first sealing element comprises a first duct, wherein in a flow direction of the to-be-treated air, a radial cross-section of the first duct becomes larger gradually, and the first duct is arranged on the air inlet side of the treatment region of the desiccant rotor and configured to allow the to-be-treated air to flow to the whole treatment region of the desiccant rotor; and a second duct, wherein the second duct is isolated from the first duct, arranged on the air outlet side of the regeneration region of the desiccant rotor and configured to discharge the regeneration air.

In some optional embodiments, the dehumidifier further comprises a case, configured for mounting the desiccant rotor; and a second sealing element arranged on the air outlet side of the treatment region and the air inlet side of the regeneration region of the desiccant rotor. The second sealing element comprises a third duct and a side opening, wherein the third duct is arranged on the air outlet side of the treatment region of the desiccant rotor and configured to discharge the to-be-treated air which is dehumidified by adsorption, and the side opening is isolated from the third duct and arranged in the air inlet side of the regeneration region of the desiccant rotor.

In some optional embodiments, the dehumidifier further comprises at least two support members detachably arranged in the case, and the desiccant rotor is rotatably arranged between the two support members; and a driving component, a driving belt, a tensioner and a limit switch are mounted on the support members, the driving belt is arranged on the desiccant rotor, the driving component is in transmission connection with the driving belt and configured to drive the desiccant rotor to rotate, the tensioner is configured to tension the driving belt, and the limit switch is triggered when the desiccant rotor rotates, to determine whether the desiccant rotor rotates.

In some optional embodiments, the dehumidifier further comprises a treatment air passage assembly and a regeneration air passage assembly. The treatment air passage assembly comprises a treatment fan, the to-be-treated air sequentially flows through the treatment air inlet, the treatment fan, the first duct of the first sealing element, the treatment region of the desiccant rotor, the third duct of the second sealing element, and the treatment air outlet. The regeneration air passage assembly comprises a regeneration fan, and the regeneration air sequentially flows through the regeneration air inlet, the regeneration region of the desiccant rotor, the second duct of the first sealing element, the regeneration fan and the regeneration air outlet.

In another aspect, the present application provides a defrosting method for a freezer. The method comprises: S1: connecting a treatment air inlet and a treatment air outlet of a dehumidification device to a freezer body; and S2: starting the dehumidification device, drawing to-be-treated air in the freezer body into the dehumidification device via the treatment air inlet, allowing the to-be-treated air to pass through a treatment region of a desiccant rotor, and transporting dry air, discharged from a treatment region of the desiccant rotor, back into the freezer body via the treatment air outlet.

In some embodiments, S2 comprises: S201: drawing out the to-be-treated air from a top of a freezer door via the treatment air inlet of the dehumidification device, discharging the dry air via the treatment air outlet, transporting the dry air in an air supply pipe, and blowing the dry air in the air supply pipe to a refrigeration device via air outlet holes to remove frost on the refrigeration device.

In some embodiments, the dehumidification device is a dehumidifier, and S2 further comprises: S202: while the to-be-treated air is dehumidified by adsorption of the dehumidifier, allowing regeneration air heated by an electric heating component, or a heat-exchange component connected to a condensation end of a refrigeration device arranged within the freezer body or generated by an air source heat pump to flow through a regeneration region of the desiccant rotor to realize desorption and dehumidification of a regeneration region, and then discharging the regeneration air, passing through the regeneration region of the desiccant rotor, via a regeneration air outlet.

The defrosting system and method for a freezer provided by the application have at least the following advantages:

The defrosting system for a freezer uses the dehumidification device, with the desiccant rotor as the core, for dehumidification and defrosting of the freezer, the desiccant rotor is more advantageous when used at a low temperature and may dry damp air in the freezer based on the principle of adsorption and desorption and discharge the damp air out of the freezer, no condensate water is produced in the whole dehumidification process of the freezer, and no water needs to be drained out of the freezer, such that the problems that cold water produced by electric defrosting, hot fluoride defrosting and other defrosting methods cannot be easily drained out and that dehumidification and defrosting in the freezer are incomplete because residual cold water, that fails to be drained out, in the freezer will be recondensed are solved; in addition, in operation of the defrosting system for a freezer, there is no obvious temperature fluctuation in the freezer, while no matter whether electric defrosting, hot fluoride defrosting or other defrosting methods are adopted, a refrigeration system of the freezer needs to be turned off to allow the temperature in the freezer to rise, thus affecting the use of the freezer and increasing power consumption of the freezer. A novel and more energy-efficient defrosting method is adopted to fundamentally solve the problem of humidity in the freezer, thus reducing the possibility of frosting in the freezer and avoiding complex operations of subsequent defrosting and water drainage.

Further, the dehumidification device provided with the desiccant rotor is adopted to dehumidify to-be-treated gas, drawn out from the bottom of the freezer, by adsorption, and dry gas is discharged from the top of the freezer to the refrigeration devices via the air outlets in the internal section to gradually remove surface frost on the refrigeration devices, such that dehumidification and defrosting in the freezer are realized; no condensate water is produced in the whole process, and no water needs to be drained out, such that the problem of incomplete dehumidification and defrosting caused by recondensation of residual cold water, that fails to be drained out, in the freezer is solved; in addition, in the dehumidification and defrosting process of the freezer, there is no obvious temperature fluctuation in the freezer, and a temperature rise of the freezer caused by turn-off of a refrigeration system of the freezer when electric defrosting, hot fluoride defrosting or other defrosting method are adopted is avoided, thus reducing energy consumption of the freezer. Moreover, condensation heat generated in operation of the freezer is used to increase the temperature of regeneration air to realize desorption of the regeneration region of the desiccant rotor, and waste heat generated in operation of the freezer is fully used, thus saving more energy.

### BRIEF DESCRIPTION OF THE DRAWINGS

FIG. 1 is a schematic structural diagram of a defrosting system for a freezer according to an embodiment of the application;

FIG. 2 is a schematic structural diagram of a dehumidifier of the defrosting system for a freezer according to an embodiment of the application;

FIG. 3 is a schematic internal structural diagram of the dehumidifier in FIG. 2 according to the application;

FIG. 3a illustrates a desiccant rotor;

FIG. 3b illustrates an electric heating component 210;

FIG. 4 is a schematic structural diagram of a first sealing element, from one perspective, according to an embodiment of the application;

FIG. 5 is a schematic structural diagram of the first sealing element, from another perspective, according to an embodiment of the application;

FIG. 6 is a schematic structural diagram of a second sealing element, from one perspective, according to an embodiment of the application;

FIG. 7 is a schematic structural diagram of the second sealing element, from another perspective, according to an embodiment of the application;

FIG. 8 is a schematic structural diagram of a desiccant rotor which is assembled with the first sealing element and the second sealing element, from one perspective, according to an embodiment of the application;

FIG. 9 is a schematic structural diagram of the desiccant rotor which is assembled with the first sealing element and the second sealing element, from another perspective, according to an embodiment of the application;

FIG. 10 is a schematic structural diagram of the defrosting system for a freezer according to another embodiment of the application;

FIG. 11 is a schematic structural diagram of the defrosting system for a freezer according to yet another embodiment of the application;

FIG. 12 is a schematic structural diagram of the defrosting system for a freezer according to yet another embodiment of the application.

In the FIGS.:
1, freezer body; 101, return pipe; 1011, extension pipe; 102, air supply pipe; 1021, external section; 1022, internal section; 1023, air outlet; 103, refrigeration device; 104, freezer door;
2, dehumidifier; 201, desiccant rotor; 202, treatment air inlet; 203, treatment air outlet; 204, regeneration air inlet; 205, regeneration air outlet; 206, first extension pipe; 207, second extension pipe; 210, electric heating component
3, heat-exchange component;
401, first duct; 402, second duct;
501, third duct; 502, side opening;
6, case; 601, support member; 602, driving component; 603, tensioner; 604, limit switch;
701, treatment fan; 702, regeneration fan;
8, heat pump system;
9, air source heat pump.

### DESCRIPTION OF THE EMBODIMENTS

Illustrative embodiments are described more comprehensively below with reference to the accompanying drawings. The illustrative embodiments may be implemented in various forms and should not be construed as being limited by those that are expounded here. On the contrary, these embodiments are provided for a more comprehensive and complete understanding of the application and for more comprehensively conveying the concept of the embodiments to those skilled in the art. Identical reference signs in the drawings indicate identical or similar structures and thus are not described repetitively.

All positional and directional terms in the application are described based on the accompanying drawings and may be changed as needed without extending beyond the protection scope of the application.

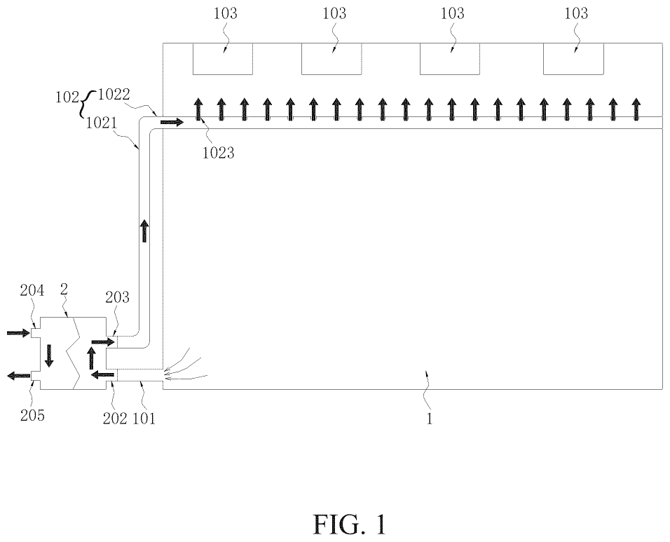

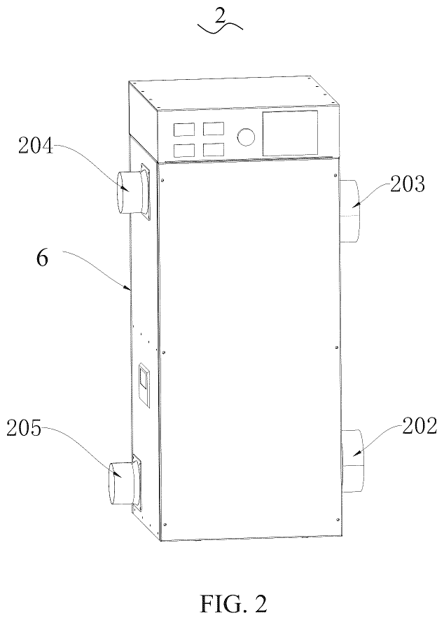

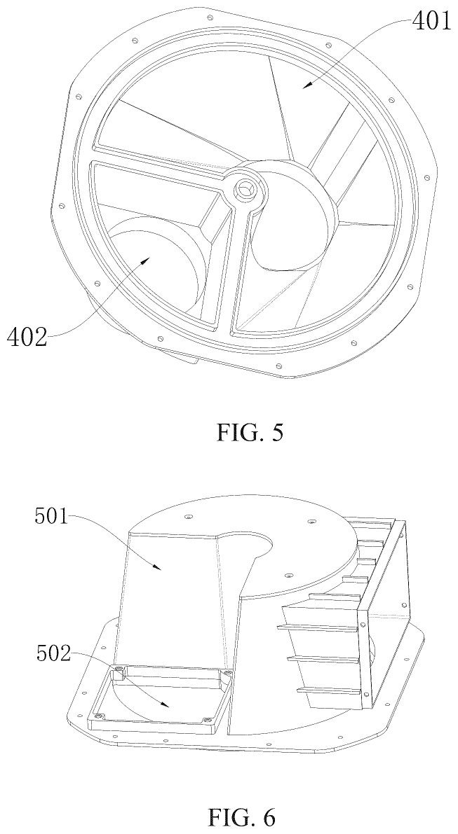

In a first aspect, referring to FIGS. 1-12, the present application provides a defrosting system for a freezer, including a freezer body 1 and a dehumidification device.

Specifically, the dehumidification device comprises a desiccant rotor 201. The desiccant rotor 201 comprises a treatment region and a regeneration region. The dehumidification device reduces moisture in the freezer body 1 and removes frost in the freezer body 1 by means of the desiccant rotor 201. Wherein, the dehumidification device comprises a treatment air inlet 202 and a treatment air outlet 203. The treatment air inlet 202 is configured to draw to-be-treated air, which is high-humidity air in the freezer body 1, out of the freezer body 1, and the treatment air outlet 203 is configured to transport dry air, which is dehumidified by adsorption of the desiccant rotor 201, back into the freezer body 1. Preferably, the freezer body 1 is provided with a return pipe 101 and an air supply pipe 102. The return pipe 101 is connected to the treatment air inlet 202, and the air supply pipe 102 is connected to the treatment air outlet 203. Wherein, the air supply pipe 102 is arranged away from the return pipe 101, which facilitating improving the air circulation effect in the freezer body 1, improving the dehumidification and defrosting efficiency of the freezer. In actual application, the air supply pipe 102 includes an external section 1021 located outside the freezer body 1 and an internal section 1022 located inside the freezer body 1, and the external section 1021 communicates with the internal section 1022. Wherein, the internal section 1022 is located at the top of the inside of the freezer body 1, and the return pipe 101 is located at the bottom of the inside of the freezer body 1. Generally, in the freezer body 1, dry air is located at the bottom, damp air is located at the top, so the top of the inside of the freezer is often visually foggy; and after the dehumidification device operates, the damp air at the top of the inside of the freezer is discharged via the return pipe 101, and dry air, which is dehumidified by adsorption, enters the freezer via the air supply pipe 102.

The defrosting system for a freezer uses the dehumidification device, with the desiccant rotor 201 as the core, for dehumidification and defrosting of the freezer, the desiccant rotor 201 is more advantageous when used at a low temperature and may dry damp air in the freezer based on the principle of adsorption and desorption and discharge the damp air out of the freezer, no condensate water is produced in the whole dehumidification process of the freezer, and no water needs to be drained out of the freezer, such that the problems that cold water produced by electric defrosting, hot fluoride defrosting and other defrosting methods cannot be easily drained out and that dehumidification and defrosting in the freezer are incomplete because residual cold water, that fails to be drained out, in the freezer will be recondensed are solved. In addition, in operation of the defrosting system for a freezer, there is no obvious temperature fluctuation in the freezer, while no matter whether electric defrosting, hot fluoride defrosting or other defrosting methods are adopted, a refrigeration system of the freezer needs to be turned off to allow the temperature in the freezer to rise, thus affecting the use of the freezer and increasing power consumption of the freezer. A novel and more energy-efficient defrosting method is adopted to fundamentally solve the problem of humidity in the freezer, thus reducing the possibility of frosting in the freezer and avoiding complex operations of subsequent defrosting and water drainage.

In some possible embodiments, referring to FIGS. 1 and 10-12, the freezer body 1 is provided with multiple refrigeration devices 103 which are configured to provide a cold source for the freezer body 1. Dry air, formed after dehumidification, is transported to the refrigeration devices 103 via the treatment air outlet 203 to remove frost of the refrigeration devices 103. In this way, when the defrosting system works, not only frost in air within the freezer body 101 may be removed, but also frost on the refrigeration devices 103 may be removed, thus maintaining good refrigeration performance of the refrigeration devices 103, reducing energy consumption of the refrigeration devices and improving the energy efficiency of the whole freezer.

In some possible embodiments, referring to FIGS. 1 and 10-12, the freezer body 1 is provided with a return pipe 101 and an air supply pipe 102, the return pipe 101 is connected to the treatment air inlet 202, and the air supply pipe 102 is connected to the treatment air outlet 203. In actual application, the return pipe 101 and the air supply pipe 102 may be made from rigid materials or flexible materials, specifically depending on the actual circumstance. In this way, the length of the treatment air inlet 202 and the treatment air outlet 203 of the dehumidification device may be extended to ensure that air at any positions in the freezer body 1 may be adsorbed for dehumidification and dry air may be transported into any positions within the freezer body 1, thus expanding the application scenarios of the defrosting system for a freezer.

In addition, the dehumidification device may be installed inside the freezer body 1 or outside the freezer body 1, and the actual installation position of the dehumidification device may be selected according to the actual circumstance. In a case where the dehumidification device is installed outside the freezer body 1, the inside and outside of the dehumidification device need to be subjected to strict thermal insulation treatment to prevent the formation of a cold bridge, and the return pipe 101 and the air supply pipe 102 also need to be subjected to strict thermal insulation treatment to reduce a temperature rise in the dehumidification process of the freezer.

In some possible embodiments, referring to FIGS. 1, 10 and 12, the dehumidification device is located outside the freezer body 1, the air supply pipe 102 includes an external section 1021 located outside the freezer body 1 and an internal section 1022 located inside the freezer body 1, the external section 1021 communicates with the internal section 1022, the external section 1021 and the internal section 1022 may be integrally formed into a single unit, and a plurality of air outlet holes 1023 facing the refrigeration devices 103 are formed in the surface of the internal section 1022. In this way, dry air discharged via the treatment air outlet 203 of the dehumidification device sequentially passes through the external section 1021, the internal section 1022 and the air outlet holes 1023 to be discharged to the refrigeration devices 103 to remove frost of the refrigeration devices 103.

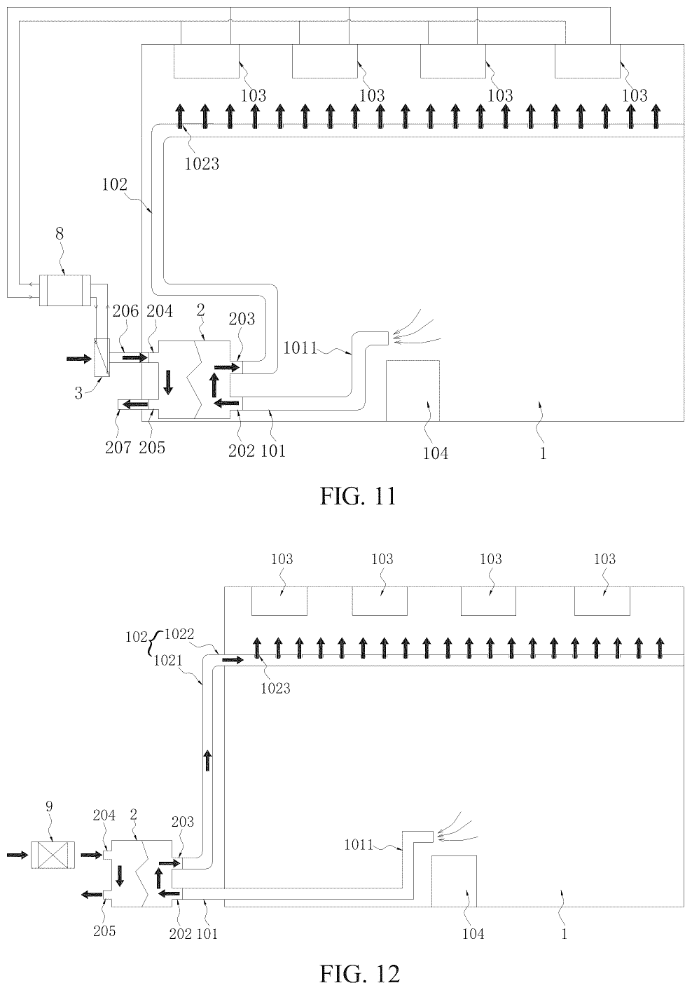

In some possible embodiments, all or at least part of the dehumidification device is located inside the freezer body 1, and a plurality of air outlet holes 1023 facing the refrigeration devices 103 are formed in the surface of the air supply pipe 102. Specifically, referring to FIG. 11, in a case where the dehumidification device is completely located inside the freezer body 1, the return pipe 101 and the air supply pipe 102 are located inside the freezer body 1, a regeneration air inlet 204 is connected to a first extension pipe 206 which penetrates through a wall body of the freezer body 1, and a regeneration air outlet 205 is connected to a second extension pipe 207 which penetrates through the wall body of the freezer body 1. In this way, dry air, discharged via the treatment air outlet 203 of the dehumidification device, sequentially passes through the air supply pipe 102 and the air outlet holes 1023 to be discharged to the refrigeration devices 103 to remove frost of the refrigeration devices 103.

For example, the refrigeration devices 103 may be arranged at the top of the inside of the freezer body 1 and may be devices using air coolers for refrigeration. For a freezer using air coolers for refrigeration, dry air, dehumidified by adsorption of the dehumidification device, is blown to the air coolers via the air outlet holes 1023 to remove frost on heat-exchange fins of the air coolers. The refrigeration devices 103 may also be devices using aluminum pipes for refrigeration. For a freezer using aluminum pipes for refrigeration, dry air, dehumidified by adsorption of the dehumidification device, is blown to the aluminum pipes via the air outlet holes 1023 to remove frost on the aluminum pipes.

It is found by study that the main moisture source causing frosting in the freezer body 1 is high-temperature and high-humidity air entering the freezer body 1 from the external environment when a door is opened and closed for placing or taking goods. To reduce the influence of the high-temperature and high-humidity air, entering the freezer body 1 from the external environment, on frosting, in some optional embodiments, referring to FIGS. 10-12, the freezer body 1 is provided with a freezer door 104, the return pipe 101 is provided with an extension pipe 1011, and an air inlet end of the extension pipe 1011 is arranged above the freezer door 104 and used for sucking air entering the freezer body 1 via the freezer door 104. In this way, when the freezer door 104 is opened for placing goods in the freezer body 1 or taking goods out of the freezer body 1, the extension pipe 1011 is able to capture and suck high-temperature and high-humidity air entering the freezer body 1 from the outside and transport the high-temperature and high-humidity air into the dehumidification device for drying, such that the quantity of high-temperature and high-humidity air entering the freezer body 1 may be reduced from the source to restrain frosting in the freezer body 1, thus improving the dehumidification effect of the frosting system for a freezer.

Preferably, referring to FIGS. 1-3a, the dehumidification device is a dehumidifier 2 in which the desiccant rotor 201 is arranged, the dehumidifier 2 comprises the regeneration air inlet 204 and the regeneration air outlet 205. The regeneration air inlet 204 is configured to transport regeneration air to an air inlet side of the regeneration region of the desiccant rotor 201 to realize desorption and regeneration of the regeneration region of the desiccant rotor 201, and the regeneration air outlet 205 is configured to discharge the regeneration air, discharged from an air outlet side of the regeneration region of the desiccant rotor 201, out of the dehumidifier 2. It should be noted that the regeneration air used for desorption and regeneration of the regeneration region of the desiccant rotor 201 may be heated ambient air from the outside of the freezer.

The treatment air inlet 202 is configured to transport to-be-treated air to an air inlet side of the treatment region 201a of the desiccant rotor 201 to realize adsorption and dehumidification of the to-be-treated air, and the treatment air outlet 203 is configured to discharge dry air, discharged from an air outlet side of the treatment region 201a of the desiccant rotor 201, out of the dehumidifier 2. It should be noted that a certain temperature rise will be caused when the to-be-treated air in the freezer is dehumidified by the dehumidifier 2. But a temperature rise, which is about 4-5° C., is extremely small in application of the freezer; and because the dry air dehumidified by adsorption has a low moisture content and a low enthalpy value, a heat load generated during operation of the refrigeration system of the refrigeration system of the freezer is small, and the increase in energy consumption caused by the temperature rise of the dry air may be ignored in actual application.

In an actual test, when the dehumidifier 2 is used for defrosting of the freezer, under the condition that the temperature in the freezer body 1 is −18° C., the humidity in the freezer body 1 is 90% RH and the moisture content in the freezer body 1 is 0.82 g/kg, the dehumidifier 2 is started to work for one hour; and one hour later, the humidity in the freezer body 1 is decreased to 42.6% RH and the moisture content is decreased to 0.39 g/kg, such that icing in the freezer may be avoided by decreasing the moisture content in the freezer; in addition, relatively dry air formed after dehumidification is blown to the frosted refrigeration devices 103 such as air coolers or aluminum pipes, to remove frost from the refrigeration devices 103 gradually. Wherein, RH refers to the relative humidity and indicates the ratio of the absolute humidity in air to the saturated absolute humidity at the same temperature and the same air pressure.

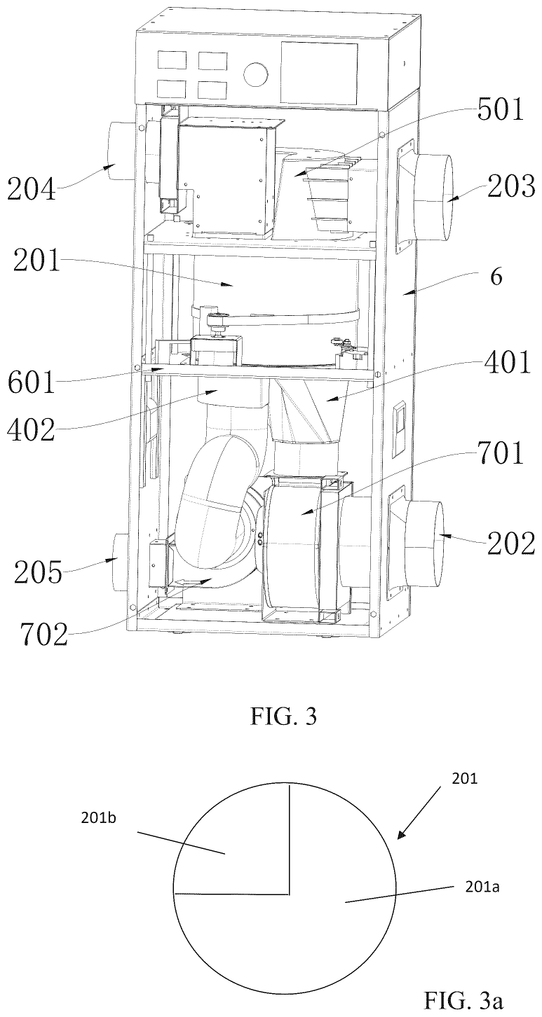

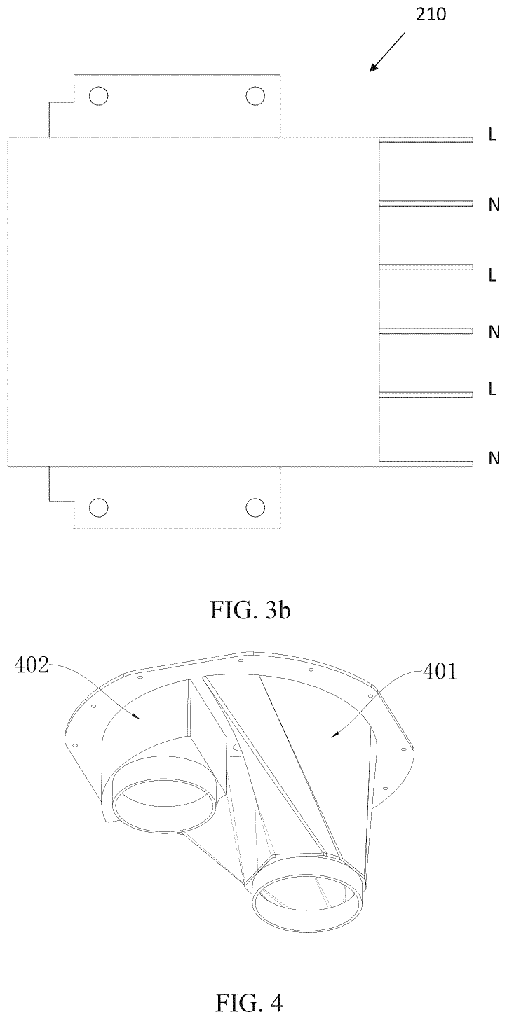

In some optional embodiments, the dehumidifier 2 further includes an electric heating component 210 (shown in FIG. 3b). The electric heating component is arranged on the air inlet side of the regeneration region of the desiccant rotor 201 and configured to increase the temperature of regeneration air. By heating the regeneration air by means of the electric heating component to realize desorption and regeneration of the regeneration region of the desiccant rotor 201, although energy consumption is relatively high, the structure of the dehumidifier 2 and the structure of the defrosting system for a freezer may be simplified, and a heat source does not need to be additionally arranged. The electric heating component may guarantee the stability of the temperature of a heat-exchange component 3, thus avoiding temperature fluctuations of the regeneration gas caused by an instable temperature of the heat-exchange component 3, which may otherwise compromise the regeneration effect of the desiccant rotor 201.

The defrosting system for a freezer further includes the heat-exchange component 3 configured to increase the temperature of regeneration air. As shown in FIG. 10, the heat-exchange component 3 is arranged at the regeneration air inlet 204. The heat-exchange component 3 is connected to condensation ends of the refrigeration devices 103 for increasing the temperature of the heat-exchange component 3. In actual applications, the heat-exchange component 3 may be a heat-exchanger. Because the regeneration region of the desiccant rotor 201 has a low requirement for the regeneration temperature, heat generated by the condensation ends of the refrigeration devices 103 of the refrigeration system of the freezer may be recycled by the heat-exchange component 3 to heat the regeneration air, the dehumidifier 2 may be used for dehumidification and defrosting of the freezer, and waste heat of the refrigeration system of the freezer body 1 may be used to heat the regeneration air of the dehumidifier 2, such that the dehumidifier 2 and the freezer body 1 work cooperatively to improve the energy-saving effect. In this way, by adding the heat-exchange component 3, condensation heat of the refrigeration devices 103 in the freezer body 1 is used to increase the temperature of the regeneration air by means of the heat-exchange component 3 to realize desorption and regeneration of the regeneration region of the desiccant rotor 201, thus improving the energy efficiency of the whole defrosting system for a freezer.

It should be noted that the heat-exchange component 3 not only may use heat generated by the condensation ends of the refrigeration devices 103 to increase the temperature of the regeneration air, but also may use waste heat of other devices as a heat source for increasing the temperature of the regeneration air. However, to improve the stability of an external heat source connected to the heat-exchange component 3, an auxiliary electric heating device is often additionally arranged on the heat-exchange component 3 to improve the stability of the temperature of the heat-exchange component 3 so as to avoid temperature fluctuations of the regeneration air caused by an instable temperature of the heat-exchange component 3, which may otherwise compromise the regeneration effect of the desiccant rotor 201.

In addition, referring to FIG. 11, on the basis of this embodiment, a heat pump system 8 for improving the temperature stability of the heat-exchange component 3 may be additionally arranged. Specifically, an evaporation end of the heat pump system 8 is connected to the condensation ends of the refrigeration devices 103, a condensation end of the heat pump system 8 is connected to the heat-exchange component 3, and the heat pump system 8 is able to recycle waste heat of the refrigeration devices 103 of the refrigeration system of the freezer to provide a stable heat source for the heat-exchange component 3 so as to make the temperature of the regeneration air heated by the heat-exchange component 3 more stable, thus improving the regeneration and desorption effect of the regeneration region of the dehumidifier 2. In this way, waste heat of the refrigeration devices of the dehumidification system of the freezer is used by the heat pump system 8 as a heat source to make the temperature of the heat-exchange component 3 more stable, such that the regeneration gas provides a stable regeneration heat source for the dehumidifier 2 to guarantee the desorption and regeneration effect of the regeneration region 201b of the dehumidifier 2, thus making the whole system higher in energy efficiency and more energy-efficient. Or,

The defrosting system for a freezer further includes an air source heat pump 9. Referring to FIG. 12, the air source heat pump 9 is arranged at the regeneration air inlet 204 and used for desorption and regeneration of the regeneration region 201b of the desiccant rotor 201. Specifically, an output end of the air source heat pump 9 is connected to the regeneration air inlet 204, and the output end of the air source heat pump 9 is capable of directly discharging high-temperature air, which is used as the regeneration air of the dehumidifier 2 to realize desorption and regeneration of the regeneration region 201b. In this way, by adopting the air source heat pump 9, pipe connection on the air inlet side of the regeneration region 201b of the dehumidifier 2 may be simplified, installation steps are relatively more flexible, and the energy-saving effect is remarkable in long-term use.

In some optional embodiments, referring to FIGS. 4, 5, 8 and 9, the dehumidifier 2 further includes a first sealing element, which is arranged on the air inlet side of the treatment region 201a and the air outlet side of the regeneration region 201b of the desiccant rotor 201. The first sealing element includes a first duct 401 and a second duct 402. It should be noted that the wall of the first duct 401 needs to be subjected to strict thermal insulation treatment to prevent the to-be-treated air inside the first duct 401 from exchanging heat with objects outside the first duct 401, to reduce a temperature rise in the process of dehumidifying the to-be-treated air by adsorption.

Wherein, the first sealing element is a special-shaped structure on the whole, the first duct 401 is also designed into a special-shaped structure, a through-hole penetrating through two sides is formed in the middle of the first sealing element, and a support shaft of the desiccant rotor 201 extends through the through-hole. In the flow direction of the to-be-treated air, a radial cross-section of the first duct 401 becomes larger gradually. The first duct 401 is arranged on the air inlet side of the treatment region 201a of the desiccant rotor 201 and is configured to allow the to-be-treated air to flow to the whole treatment region 201a of the desiccant rotor 201. Specifically, the first duct 401 is a hollow quasi-frustum with a small-area top end inclining towards one side of the central axis rather than a regular hollow frustum structure. The wall of the first duct 401 is preferably special-shaped and has a variable diameter. More specifically, the special shape and variable diameter allow for a gradual increase in the radial cross-section in the first duct 401 to realize a natural transition of the inside of the wall of the first duct 401, and no dead corner exists in the first duct 401, such that the flow field of the to-be-treated air entering the first duct 401 is more uniform, the surface of the whole treatment region 201a of the desiccant rotor 201 may be effectively used, and the airflow is prevented from being accumulated on part of the surface of the treatment region 201a, thus improving the dehumidification efficiency of the desiccant rotor 201.

The second duct 402 is isolated from the first duct 401, arranged on the air outlet side of the regeneration region 201b of the desiccant rotor 201, and configured to discharge the regeneration air.

For example, end surfaces, matched with the desiccant rotor 201, of the first duct 401 and the second duct 402 form a circular covering surface, and a round port is formed in the other end surface of the first duct 401 and configured to be connected to an external pipe or the like. The circular covering surface may wrap around an end surface of the desiccant rotor 201. For example, the area of the treatment region 201a of the desiccant rotor 201 is three quarters of the area of the end surface, and the area of the regeneration region is a quarter of the area of the end surface, such that the treatment region 201a and the regeneration region form the complete end surface of the desiccant rotor 201. Adaptively, the first duct 401 is designed to be three quarters of the circular covering surface corresponding to the area of the treatment region 201a, and the second duct 402 is designed to be a quarter of the circular covering surface corresponding to the area of the regeneration region.

It should be noted that the inside of the first duct 401 having one end provided with the circular port and the other end being three quarters of the circular covering surface is special-shaped and adopts a variable diameter to allow for a gradual increase in the radial cross-section of the first duct 401, such that the flow field of the to-be-treated air entering the first duct 401 is more uniform, the surface of the whole treatment region 201a of the desiccant rotor 201 may be effectively used, and the airflow is prevented from being accumulated on part of the surface of the treatment region 201a, thus improving the dehumidification efficiency of the desiccant rotor 201.

In view of this, the first sealing element is integrally made from a high-strength and high-temperature-resistance plastic structure, and the wall of the first duct 401 of the first sealing element is designed into a special-shaped and variable-diameter special structure with the radial cross-section becoming larger gradually to ensure that the flow field of air discharged from the first duct 401 is more uniform to promote the airflow to reach the whole treatment region 201a of the desiccant rotor 201, such that the surface of the whole treatment region 201a of the desiccant rotor 201 is effectively used, dead corners in the treatment region 201a are eliminated, and the dehumidification efficiency of the desiccant rotor 201 is improved, thus further improving the dehumidification effect of the dehumidifier 2 on the to-be-treated air with high-humidity in the freezer and effectively avoiding frosting in the freezer.

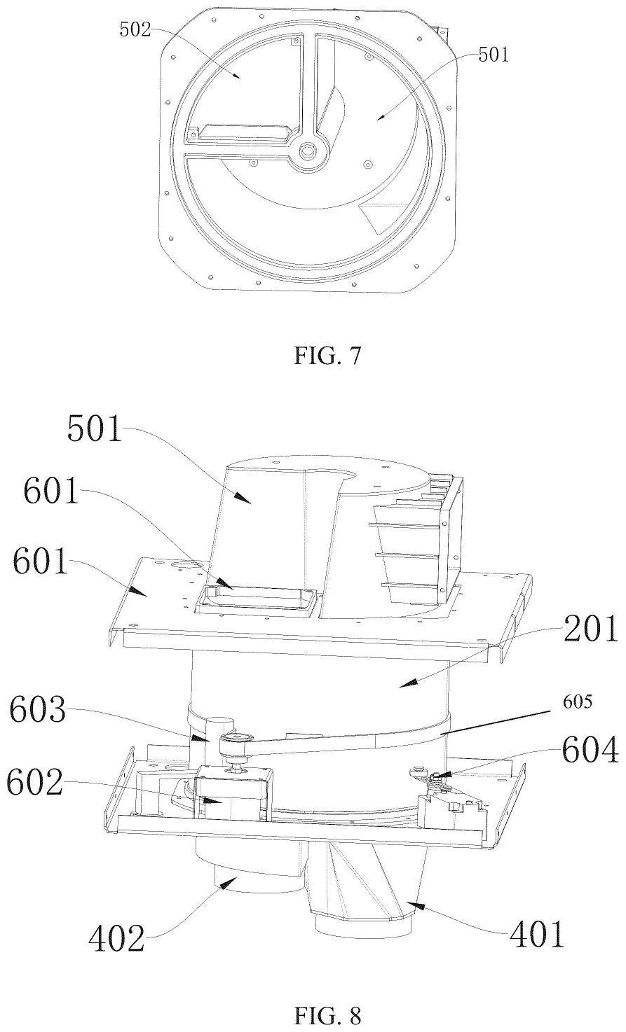

In some optional embodiments, referring to FIGS. 6, 7. 8 and 9, the dehumidifier 2 further includes a case 6 and a second sealing element.

Wherein, the case 6 is configured for mounting the desiccant rotor 201. It should be noted that the inside and the outside of the case 6 need to be subjected to strict thermal insulation treatment to prevent a cold bridge from being formed at the position of the dehumidifier 2 of the defrosting system for a freezer.

The second sealing element is arranged at the air outlet side of the treatment region and the air inlet side of the regeneration region 201b of the desiccant rotor 201 and includes a third duct 501 and a side opening 502. The third duct 501 is arranged on the air outlet side of the treatment region 201a of the desiccant rotor 201 and configured to discharge the to-be-treated air dehumidified by adsorption. The side opening 502 is isolated from the third duct 501 and formed in the air inlet side of the regeneration region 201b of the desiccant rotor 201. It should be noted that the wall of the third duct 501 needs to be subjected to strict thermal insulation treatment to prevent dry air in the third duct 501 from exchanging heat with objects outside the third duct 501 to reduce a temperature rise of the dry gas.

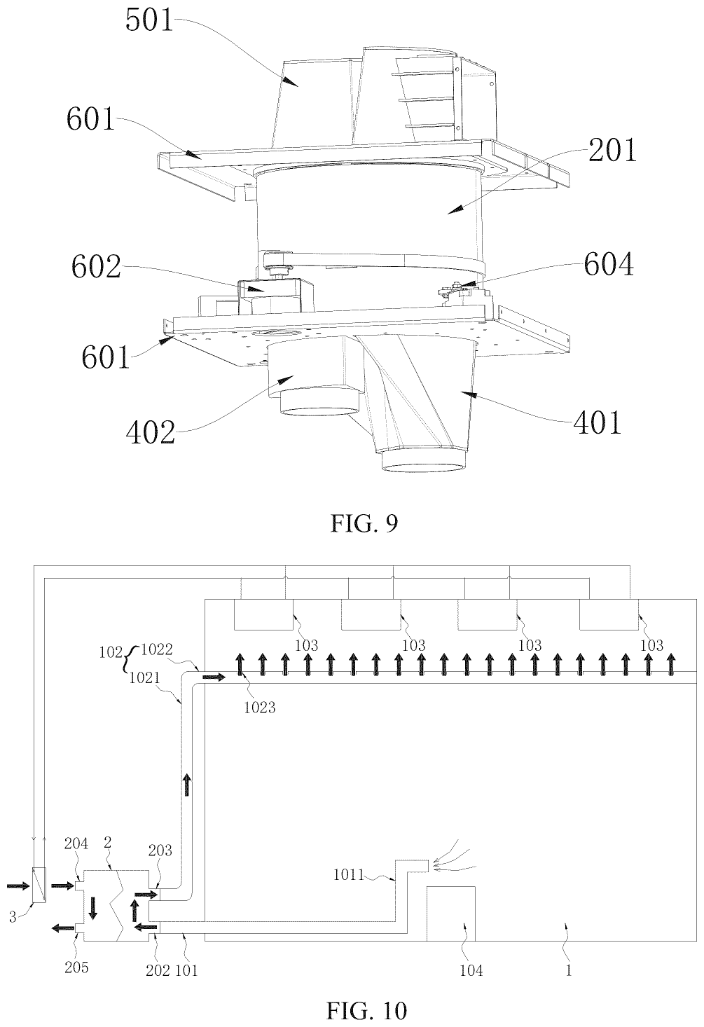

In this embodiment, referring to FIGS. 8 and 9, the dehumidifier 2 further includes at least two support members 601 detachably arranged in the case 6, and the desiccant rotor 201 is rotatably arranged between the two adjacent support members 601. It should be noted that circular tracks or rails for the desiccant rotor 201 to rotate are arranged on surfaces, facing each other, of the two adjacent support members 601. The support members 601 are preferably platy structures, and through-opening structures are formed in inner sides of the circular tracks of the support members 601 configured as the platy structures, such that regeneration air or the to-be-treated air may smoothly pass through the treatment region 201a and the regeneration region 201b of the desiccant rotor 201.

A driving component 602, a driving belt, a tensioner 603 and a limit switch 604 are mounted on the support members 601. The driving belt is arranged on the desiccant rotor 201. The driving component 602 is in transmission connection with the driving belt and configured to drive the desiccant rotor 201 to rotate. The tensioner 603 is configured to tension the driving belt. The limit switch 604 is triggered when the desiccant rotor 201 rotates, to determine whether the desiccant rotor 201 rotates. It should be noted that the driving component 602 may be a driving motor, a belt wheel connected to the driving belt is mounted at an output end of the driving motor, the driving belt is wound around the desiccant rotor 201, the tensioner 603, the belt wheel and the limit switch 604, and the driving motor, when working, drives the desiccant rotor 201 to rotate through the driving belt. Wherein, every time the desiccant rotor 201 rotates for a revolution, the limit switch 604 is triggered once. A time setting is configured in a program of the dehumidifier system, and if the limit switch 604 is not triggered within a predetermined time interval, the program will determine that the desiccant rotor 201 breaks down or does not rotate, such that the working process of the desiccant rotor 201 is monitored.

In some optional embodiments, referring to FIGS. 3, 8 and 9, the dehumidifier 2 further includes a treatment air passage assembly and a regeneration air passage assembly.

The treatment air passage assembly includes a treatment fan 701, and the to-be-treated air sequentially flows through the treatment air inlet 202, the treatment fan 701, the first duct 401 of the first sealing element, the treatment region 201a of the desiccant rotor 201, the third duct 501 of the second sealing element, and the treatment air outlet 203. Wherein, an air outlet of the treatment fan 701 communicates with the first duct 401, the treatment air outlet 203 communicates with the third duct 501, and a filter element for filtering out dust may be mounted between the treatment air inlet 202 and the treatment fan 701. Dust particles over 5μm in the to-be-treated air may be filtered out by the filter element to prevent the treatment region 201a of the desiccant rotor 201 from being blocked.

The regeneration air passage assembly includes a regeneration fan 702. Regeneration air sequentially flows through the regeneration air inlet 204, the side opening 502, the regeneration region 201b of the desiccant rotor 201, the second duct 402 of the first sealing element, the regeneration fan 702 and the regeneration air outlet 205. Wherein, the second duct 402 is connected to an air inlet of the regeneration fan 702, and a filter element is mounted between the regeneration air inlet 204 and the side opening 502 to filter out dust particles over 5μm from the to-be-treated air to prevent the treatment region 201a of the desiccant rotor 201 from being blocked.

In a second aspect, the application further provides a defrosting method for a freezer. The defrosting method adopts the defrosting system for a freezer and includes the following steps: S1, the treatment air inlet 202 and the treatment air outlet 203 of the dehumidification device are connected to the freezer body 1; and S2, the dehumidification device is started, the to-be-treated air in the freezer body 1 is drawn into the dehumidification device via the treatment air inlet 202 and passes through the treatment region 201a of the desiccant rotor 201, and dry air discharged from the treatment region 201a of the desiccant rotor 201 is transported back into the freezer body 1 via the treatment air outlet 203. Wherein, S2 includes the following step: S201, the to-be-treated air is drawn out from the top of the freezer door 104 via the treatment air inlet 202 of the dehumidification device, the dry air discharged via the treatment air outlet 203 is transported in the air supply pipe 102, and the dry air in the air supply pipe 102 is blown to the refrigeration devices 103 via the air outlet holes 1023 to remove frost on the regeneration devices 103. Wherein, S2 further includes: while the to-be-treated air is dehumidified by adsorption of the dehumidifier, regeneration air is heated by the electric heating component, or the heat-exchange component 3 connected to the condensation ends of the refrigeration devices 103 or is generated by the air source heat pump and flows through the regeneration region 201b of the desiccant rotor 201 to realize desorption and regeneration of the regeneration region 201b, and the regeneration air passing through the regeneration region 201b of the desiccant rotor 201 is discharged via the regeneration air outlet 205.

Specifically, referring to FIGS. 10 and 11, with the dehumidifier 2 as the dehumidification device, the treatment air inlet 202 of the dehumidifier is connected to the return pipe 101, the treatment air outlet 203 is connected to the air supply pipe 102, the dehumidifier 2 is started to draw out the high-humidity to-be-treated air from the bottom of the freezer body 1 and particularly when goods are placed in or taken out of the freezer body 1, to draw out high-temperature and high-humidity air, just entering the freezer body 1 from the outside, from the top of the freezer door 104, and dry air, dehumidified by adsorption of the desiccant rotor 201, is discharged via the treatment air outlet 203, enters the internal section 1022 through the external section 1021 and is blown to the refrigeration devices 103 via the air outlet holes 1023 to gradually remove frost on the refrigeration devices 103; and in this process, condensation heat of the condensation ends of the refrigeration devices 103 directly passes through the heat-exchange component 3 to increase the temperature of the heat-exchange component 3, or the condensation heat of the condensation ends of the refrigeration devices 103 passes through the heat pump system 8 and the condensation heat passing through the condensation end of the heat pump system passes through the heat-exchange component 3 to increase the temperature of the heat-exchange component 3; and regeneration air, after being heated by the heat-exchange component 3, is drawn in via the regeneration air inlet 204 to realize desorption and regeneration of the desiccant rotor 201, and the high-humidity regeneration air is discharged to the outside via the regeneration air outlet 205.

It should be noted that in a case where the dehumidifier 2 includes the electric heating component arranged on the air inlet side of the regeneration region 201b of the desiccant rotor 201, the regeneration air does not need to be heated by the heat-exchange component 3, and when the regeneration air enters the dehumidifier 2 via the regeneration air inlet 204, the regeneration air is heated by the electric heating component to satisfy the requirement for the regeneration temperature of the regeneration region 201b of the desiccant rotor 201, thus realizing desorption and regeneration of the desiccant rotor 201.

The dehumidification device with the desiccant rotor 201 is adopted to dehumidify the to-be-treated air, drawn out from the bottom of the freezer, by adsorption, and dry air is discharged from the top of the freezer to the refrigeration devices 103 via the air outlet holes 1023 in the internal section 1022 to gradually remove frost on the surface of the refrigeration devices 103, such that dehumidification and defrosting in the freezer are realized; no condensate water is produced in the whole process, and no water needs to be drained out, such that the problem of incomplete dehumidification and defrosting caused by recondensation of residual cold water, that fails to be drained out, in the freezer is solved; in addition, in the dehumidification and defrosting process of the freezer, there is no obvious temperature fluctuation in the freezer, and a temperature rise of the freezer caused by turn-off of a refrigeration system of the freezer when electric defrosting, hot fluoride defrosting or other defrosting method are adopted is avoided, thus reducing energy consumption of the freezer; moreover, condensation heat generated in operation of the freezer is used to increase the temperature of regeneration gas to realize desorption of the regeneration region 201b of the desiccant rotor 201, and waste heat generated in operation of the freezer is fully used, thus saving more energy.

What is claimed is:

1. A defrosting system for a freezer, the defrosting system comprising:
a freezer body (1); and
a dehumidification device comprising a desiccant rotor (201) which comprises a treatment region (201a) and a regeneration region (201b), the dehumidification device being configured for reducing moisture in the freezer body (1) and removing frost in the freezer body (1) by means of the desiccant rotor (201);
wherein the dehumidification device comprises a treatment air inlet (202) and a treatment air outlet (203), the treatment air inlet (202) is configured to draw to-be-treated air out of the freezer body (1), and the treatment air outlet (203) is configured to transport dry air, dehumidified by adsorption of the desiccant rotor (201), back into the freezer body (1).

2. The defrosting system for a freezer according to claim 1, wherein a refrigeration device (103), which is configured to provide a cold source for the freezer body (1), is arranged within the freezer body (1); and
the dry air is transported to the refrigeration device (103) via the treatment air outlet (203) to remove frost on the refrigeration device (103).

3. The defrosting system for a freezer according to claim 2, wherein the freezer body (1) is provided with a return pipe (101) and an air supply pipe (102), the return pipe (101) is connected to the treatment air inlet (202), and the air supply pipe (102) is connected to the treatment air outlet (203).

4. The defrosting system for a freezer according to claim 3, wherein the dehumidification device is located outside the freezer body (1), the air supply pipe (102) comprises an external section (1021) located outside the freezer body (1) and an internal section (1022) located inside the freezer body (1), the external section (1021) communicates with the internal section (1022), and a plurality of air outlet holes (1023) facing the refrigeration device (103) are formed in a surface of the internal section (1022); or
all or at least part of the dehumidification device is located inside the freezer body (1), and a plurality of air outlet holes (1023) facing the refrigeration device (103) are formed in a surface of the air supply pipe (102).

5. The defrosting system for a freezer according to claim 3, wherein all or at least part of the dehumidification device is located inside the freezer body (1), and a plurality of air outlet holes (1023) facing the refrigeration device (103) are formed in a surface of the air supply pipe (102).

6. The defrosting system for a freezer according to claim 4, wherein the freezer body (1) is provided with a freezer door (104), the return pipe (101) is provided with an extension pipe (1011), and an air inlet end of the extension pipe (1011) is arranged above the freezer door (104) and used for sucking air entering the freezer body (1) via the freezer door (104).

7. The defrosting system for a freezer according to claim 6, wherein the dehumidification device is a dehumidifier (2) which comprises a regeneration air inlet (204) and a regeneration air outlet (205), the regeneration air inlet (204) is configured to transport regeneration air to an air inlet side of the regeneration region (201b) of the desiccant rotor (201) to realize desorption regeneration of the regeneration region (201b) of the desiccant rotor (201), and the regeneration air outlet (205) is configured to discharge the regeneration air, discharged from an air outlet side of the regeneration region (201b) of the desiccant rotor (201), out of the dehumidifier (2); and
the treatment air inlet (202) is configured to transport the to-be-treated air to an air inlet side of the treatment region (201a) of the desiccant rotor (201) to realize dehumidification of the to-be-treated air by absorption, and the treatment air outlet (203) is configured to discharge the dry air, discharged from an air outlet side of the treatment region (201a) of the desiccant rotor (201), out of the dehumidifier (2).

8. The defrosting system for a freezer according to claim 7, wherein the dehumidifier (2) further comprises an electric heating component (210) arranged on the air inlet side of the regeneration region (201b) of the desiccant rotor (201) and configured to increase a temperature of the regeneration air;
the defrosting system further comprises a heat-exchange component (3) for increasing the temperature of the regeneration air, and the heat-exchange component (3) is arranged at the regeneration air inlet (204), connected to a condensation end of the refrigeration device (103) and configured to increase the temperature of the regeneration air via the heat-exchange component (3); or
the defrosting system further comprises an air source heat pump (8) arranged at the regeneration air inlet (204) and configured to provide the regeneration air to realize desorption and regeneration of the regeneration region (201b) of the desiccant rotor (201).

9. The defrosting system for a freezer according to claim 7, wherein the dehumidifier (2) further comprises a first sealing element arranged on the air inlet side of the treatment region (201a) and the air outlet side of the regeneration region (201b) of the desiccant rotor (201), and the first sealing element comprises:
a first duct (401), wherein in a flow direction of the to-be-treated air, a radial cross-section of the first duct (401) becomes larger gradually, and the first duct (401) is arranged on the air inlet side of the treatment region (201a) of the desiccant rotor (201) and configured to allow the to-be-treated air to flow to all parts of the treatment region (201a) of the desiccant rotor (201); and
a second duct (402), wherein the second duct (402) is isolated from the first duct (401), arranged on the air outlet side of the regeneration region (201b) of the desiccant rotor (201) and configured to discharge the regeneration air.

10. The defrosting system for a freezer according to claim 9, wherein the dehumidifier (2) further comprises:
a case (6), configured for mounting the desiccant rotor (201); and
a second sealing element arranged on the air outlet side of the treatment region (201a) and the air inlet side of the regeneration region (201b) of the desiccant rotor (201);
wherein the second sealing element comprises a third duct (501) and a side opening (502), wherein the third duct (501) is arranged on the air outlet side of the treatment region (201a) of the desiccant rotor (201) and configured to discharge the to-be-treated air which is dehumidified by adsorption, and the side opening (502) is isolated from the third duct (501) and arranged in the air inlet side of the regeneration region (201b) of the desiccant rotor (201).

11. The defrosting system for a freezer according to claim 10, wherein the dehumidifier (2) further comprises at least two support members (601) detachably arranged in the case (6), and the desiccant rotor (201) is rotatably arranged between the two support members (601); and
a driving component (602), a driving belt (605), a tensioner (603) and a limit switch (604) are mounted on the support members (601), the driving belt is arranged on the desiccant rotor (201), the driving component (602) is in transmission connection with the driving belt and configured to drive the desiccant rotor (201) to rotate, the tensioner (603) is configured to tension the driving belt, and the limit switch (604) is triggered when the desiccant rotor (201) rotates, to determine whether the desiccant rotor (201) rotates.

12. The defrosting system for a freezer according to claim 10, wherein the dehumidifier (2) further comprises a treatment air passage assembly and a regeneration air passage assembly;
the treatment air passage assembly comprises a treatment fan (701), the to-be-treated air sequentially flows through the treatment air inlet (202), the treatment fan (701), the first duct (401) of the first sealing element, the treatment region (201a) of the desiccant rotor (201), the third duct (501) of the second sealing element, and the treatment air outlet (203); and
the regeneration air passage assembly comprises a regeneration fan (702), and the regeneration air sequentially flows through the regeneration air inlet (204), the regeneration region (201b) of the desiccant rotor (201), the second duct (402) of the first sealing element, the regeneration fan (702) and the regeneration air outlet (205).

13. A defrosting method for a freezer, comprising:
S1: connecting a treatment air inlet (202) and a treatment air outlet (203) of a dehumidification device to a freezer body (1); and
S2: starting the dehumidification device, drawing to-be-treated air in the freezer body (1) into the dehumidification device via the treatment air inlet (202), allowing the to-be-treated air to pass through a treatment region (201a) of a desiccant rotor (201), and transporting dry air, discharged from a treatment region (201a) of the desiccant rotor (201), back into the freezer body (1) via the treatment air outlet (203).

14. The defrosting method according to claim 13, wherein S2 comprises:
S201: drawing out the to-be-treated air from a top of a freezer door (104) via the treatment air inlet (202) of the dehumidification device, discharging the dry air via the treatment air outlet (203), transporting the dry air in an air supply pipe (102), and blowing the dry air in the air supply pipe (102) to a refrigeration device (103) via air outlet holes (1023) to remove frost on the refrigeration device (103).

15. The defrosting method according to claim 13, wherein the dehumidification device is a dehumidifier (2), and S2 further comprises:
S202: while the to-be-treated air is dehumidified by adsorption of the dehumidifier (2), allowing regeneration air heated by an electric heating component, or a heat-exchange component (3) connected to a condensation end of a refrigeration device (103) arranged within the freezer body (1) or generated by an air source heat pump to flow through a regeneration region (201b) of the desiccant rotor (201) to realize desorption and regeneration of the regeneration region, and then discharging the regeneration air, passing through the regeneration region of the desiccant rotor (201), via a regeneration air outlet (205).
